(19) United States
(12) Patent Application Publication
(10) Pub. No.: US 2024/0163966 A1
(43) Pub. Date: May 16, 2024

(54) METHOD OF CONFIGURING PC5 DRX OPERATION IN 5G NETWORK

(71) Applicant: INTERDIGITAL PATENT HOLDINGS, INC., Wilmington, DE (US)

(72) Inventors: Hongkun LI, Malvern, PA (US); Michael STARSINIC, Newtown, PA (US); Quang LY, North Wales, PA (US); Catalina MLADIN, Hatboro, PA (US); Jiwan NINGLEKHU, Royersford, PA (US); Pascal ADJAKPLE, Great Neck, NY (US)

(21) Appl. No.: 18/552,555

(22) PCT Filed: Mar. 25, 2022
(86) PCT No.: PCT/US2022/021958

§ 371 Date: Sep. 26, 2023

Related U.S. Application Data
(60) Provisional application No. 63/166,583, filed on Mar. 26, 2021.

(51) Int. Cl. H04W 76/28; H04W 40/02

(52) U.S. Cl. CPC H04W 76/28; H04W 40/02; H04W 92/18

(57) ABSTRACT

Methods, apparatus, and systems are described for improved discontinuous reception (DRX) for PCS communication (e.g., including unicast, groupcast and broadcast) for a User Equipment (UE) and particularly for reducing the power consumption.

### CROSS-REFERENCE TO RELATED APPLICATIONS

This application claims the benefit of U.S. Provisional Application No. 63/166,583, filed Mar. 26, 2021, entitled “Method of Configuring PC5 DRX Operation in 5G Network,” the contents of which is hereby incorporated by reference in its entirety.

### BACKGROUND

A PC5 DRX configuration process describes how a UE determines its PC5 DRX parameters. For example, a PC5 DRX configuration process may define how a UE determines when to use PC5 DRX, the length of its PC5 DRX cycles, when to stop using PC5 DRX, and when a PC5 DRX cycle begins and ends. It may be desired to develop a PC5 DRX configuration process (e.g., based on PC5 protocol stacks and PC5 link models) for enabling PC5 DRX operation in order to achieve improved power efficiency.

Configuring PC5 DRX operation in 5G networks may encompass a wide variety of scenarios, servers, gateways, and devices, such as those described in, for example: 3GPP TS 23.501, System Architecture for the 5G System; Stage 2; 3GPP TS 23.502, Procedures for the 5G System; Stage 2; 3GPP TR 23.776, Study on architecture enhancements for 3GPP support of advanced Vehicle-to-Everything (V2X) services, stage 2, Release 17, v1.0.0; and 3GPP TS 23.287, Architecture enhancements for 5G System (5GS) to support Vehicle-to-Everything (V2X) services, stage 2, v16.5.0, 2020-12.

### SUMMARY

Described herein are methods, apparatus, and systems for improved DRX for PC5 communication (e.g., including unicast, groupcast and broadcast), e.g., moving a UE's paging occasion to coordinate PC5 DRX and Uu DRX parameters.

According to some aspects, an overall procedure of PC5 DRX negotiation and configuration is presented, e.g., showing a functional split from an architectural and protocol stack perspective.

According to some aspects, information provided by an application layer helps generate assistance information for PC5 DRX configuration.

According to some aspects, assistance information is generated and provisioned to an AS layer for PC5 DRX configuration. In one aspect, a network provides the assistance information to a UE for the PC5 DRX configuration.

According to some aspects, operations are performed at a UE and a network once an AS layer provides determined PC5 DRX parameters. In one aspect, an application layer may change the starting point and active transmission window to adapt to the PC5 DRX parameters. In one aspect, a URSP rule may be enhanced by the network to reflect the PC5 DRX configuration.

According to some aspects, a method of coordinating PC5 DRX and Uu DRX may include moving a UE's paging occasion.

According to some aspects, an apparatus may include a first UE. The apparatus may include a processor, communications circuitry, and a memory. The memory may store instructions that, when executed by the processor, cause the apparatus to perform one or more operations. According to some aspects, one or more steps may be included in a method.

According to some aspects, the first UE may receive assistance information from a network (e.g., a 5G network). For example, the assistance information may be received in an NAS message or an application message. Moreover, the assistance information may include one or more of a service type, an indication of a unicast communication type, or one or more QoS Parameters.

According to some aspects, a first access stratum layer of the first UE may determine a PC5 DRX cycle based on the assistance information.

According to some aspects, the first access stratum layer of the first UE may receive data from a second access stratum layer of a second UE by using the PC5 DRX cycle.

According to some aspects, the first access stratum layer of the first UE may perform a negotiation with a second access stratum layer of a second UE using the PC5 DRX cycle. Based on the negotiation with the second access stratum layer of the second UE, the first UE may determine one or more parameters associated with a PC5 DRX configuration process.

According to some aspects, the first UE may configure a PC5 interface based on the one or more parameters associated with the PC5 DRX configuration process. For example, the first access stratum layer of the first UE may provide the determined one or more parameters to a V2X layer.

According to some aspects, an NAS message may be sent by the first UE to the network, where the NAS message coordinates the PC5 DRX cycle and a Uu DRX cycle.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 shows an example of a 5G System Service-based architecture;

FIG. 2 shows an example of a Non-Roaming 5G System Architecture in Reference Point Representation;

FIG. 3 shows an example of a Non-roaming 5G System architecture for V2X communication over PC5 and Uu reference points;

FIG. 4 shows an example of PC5 Unicast Links;

FIG. 5 shows an example of a Control Plane for NR PC5 reference point;

FIG. 6 shows an example of a User Plane for NR PC5 reference point;

FIG. 7 shows an example of an Overall Procedure of PC5 DRX Configuration for Unicast Communication; and

FIG. 8 shows an example of a User Interface to Configure PC5 DRX Information and Policy;

FIG. 9A illustrates an example communications system.

FIGS. 9B, 9C, and 9D are system diagrams of example RANs and core networks.

FIG. 9E illustrates another example communications system.

FIG. 9F is a block diagram of an example apparatus or device, such as a WTRU.

FIG. 9G is a block diagram of an exemplary computing system.

### DETAILED DESCRIPTION

Table 0.1 describes some of the abbreviations used herein.

TABLE 0.1
Abbreviations

| | |
|---|---|
| 5GC | 5G Core Network |
| AF | Application Function |
| AMF | Access and Mobility Management Function |
| API | Application Program Interface |
| AS | Access Stratum |
| CM | Connection Management |
| CN | Core Network |
| CP | Control Plane |
| DC | Dual Connectivity |
| DL | Downlink |
| DRX | Discontinuous Reception |
| EPS | Evolved Packet System |
| GUTI | Globally Unique Temporary UE Identity |
| IE | Information Element |
| IMSI | International Mobile Subscriber Identity |
| MM | Mobility Management |
| NAS | Non-Access Stratum |
| NF | Network Function |
| NR | New Radio |
| NSI | Network Slice Instance |
| NWDAF | Network Data Analytics Function |
| PCF | Policy Control Function |
| PDU | Packet Data Unit |
| PSA | PDU Session Anchor |
| QoS | Quality of Service |
| NG-RAN | Next Generation Radio Access Network |
| RAT | Radio Access Technology |
| RM | Registration Management |
| SSC | Session and Service Continuity |
| SM | Session Management |
| SMF | Session Management Function |
| S-NSSAI | Single Network Slice Selection Assistance Information |
| UE | User Equipment |
| UL | Uplink |
| UP | User Plane |
| URLLC | Ultra-Reliable Low Latency Communication |
| URSP | UE Route Selection Policy |
| V2X | Vehicle-to-Everything |

### 5G Network Architecture

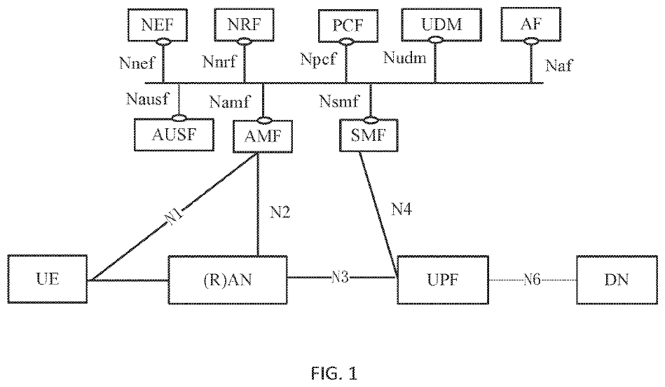

FIG. 1 shows a 5G System in a non-roaming reference architecture with service-based interfaces within the Control Plane.

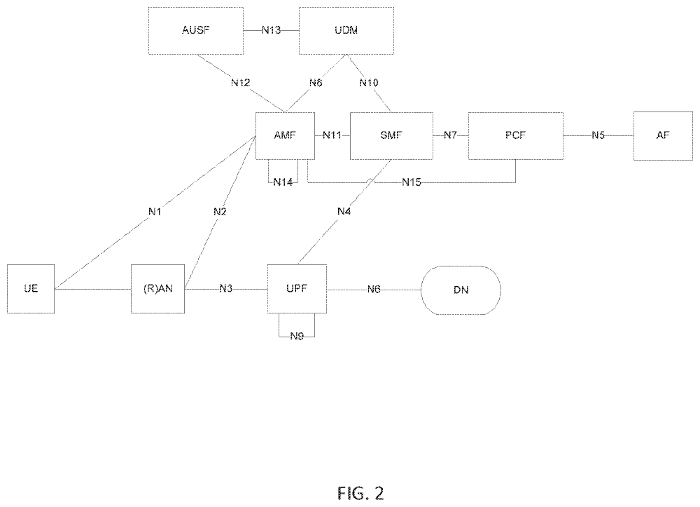

FIG. 2 depicts the 5G System architecture in the non-roaming case, using a reference point representation showing how various network functions interact with each other.

The end-to-end communications, between the Application in the UE and the Application in the external network, may use services provided by the 3GPP system, and optionally services provided by a Services Capability Server (SCS), which reside in the DN.

### DRX Framework in 5GC

In one aspect, the 5G System supports DRX architecture where Idle mode DRX cycle is negotiated between a UE and the AMF. For example, the Idle mode DRX cycle applies in CM-IDLE state and in CM-CONNECTED with RRC Inactive state.

In one aspect, if the UE wants to use UE specific DRX parameters, the UE may include its preferred values consistently in every Initial Registration and Mobility Registration procedure separately for NR/WB-EUTRA and NB-IoT. The normal 5GS procedures may apply during Initial Registration and Mobility Registration procedures performed on NB-IoT cells.

In one aspect, the AMF may determine Accepted DRX parameters based on received UE specific DRX parameters and the AMF may accept the UE requested values (e.g., subject to operator policy the AMF may change the UE requested values).

The AMF may respond to the UE with the Accepted DRX parameters separately for NR/WB-EUTRA and NB-IoT.

In one aspect, the UE may apply the DRX cycle broadcast in the cell by the RAN unless it has received Accepted DRX parameters from the AMF in which case the UE may apply either the DRX cycle broadcast in the cell or the Accepted DRX parameters, as defined in TS 38.304 and TS 36.304.

In one aspect, the Periodic Registration procedure may not change the UE's DRX settings.

In CM-CONNECTED with RRC Inactive state, the UE may apply either the DRX cycle negotiated with AMF, or the DRX cycle broadcast by RAN or the UE specific DRX cycle configured by RAN, as defined in TS 38.300 and TS 38.304.

### V2X Service in 5G

### V2X Service in Release 16

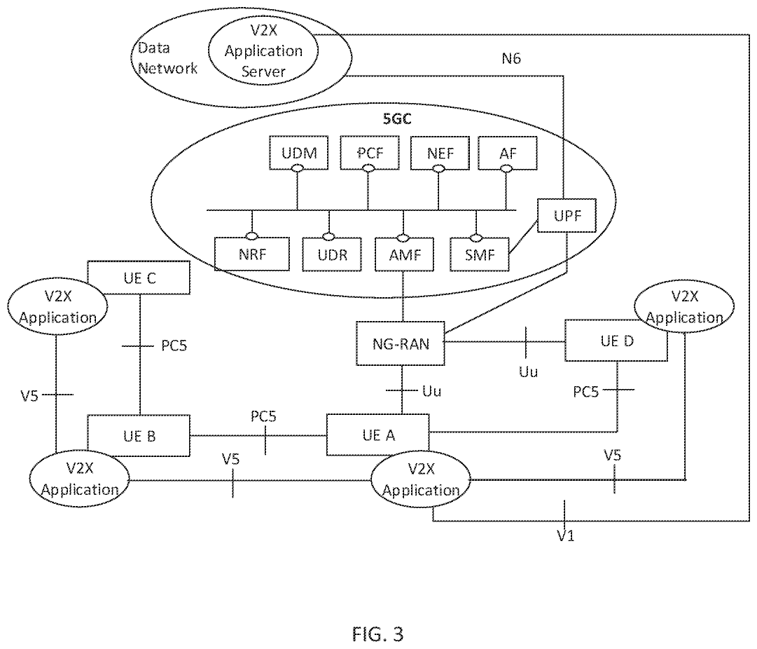

In one aspect, there are two modes of operation for V2X communication, namely V2X communication over PC5 reference point and V2X communication over Uu reference point. These two operational modes may be used by a UE independently for transmission and reception. V2X communications over PC5 reference point may be supported by LTE and/or NR. FIG. 3 shows a 5G architecture of V2X communication over PC5 and Uu interfaces for non-roaming scenario.

In one aspect, the parameters (e.g., V2X service type, authorization policy and radio parameters) for V2X communications over PC5 and Uu reference points may be made available to the UE in the following ways: pre-configured in the ME; configured in the UICC; preconfigured in the ME and configured in the UICC; provided/updated by the V2X Application Server via PCF and/or V1 reference point; and provided/updated by the PCF to the UE.

In one aspect, V2X communication over LTE based PC5 reference point is connectionless, e.g., broadcast mode at Access Stratum (AS) layer, and there is no signaling over PC5 for connection establishment.

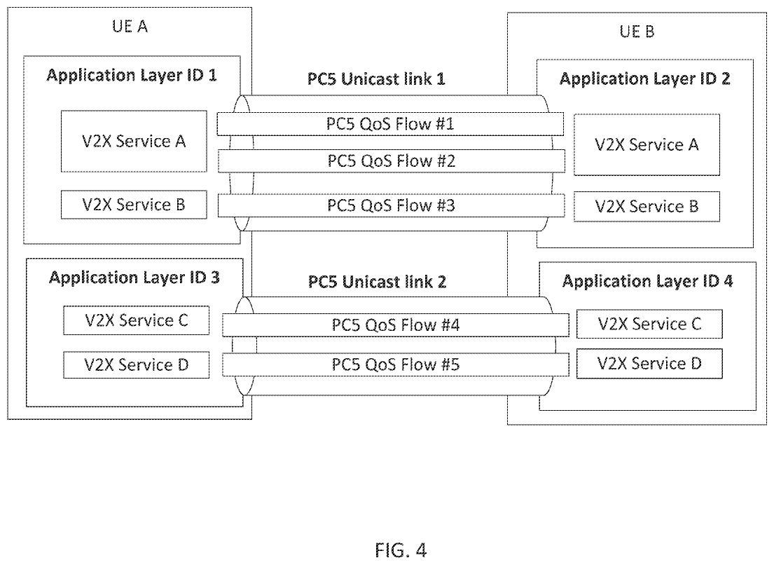

In one aspect, V2X communication over NR based PC5 reference point supports broadcast mode, groupcast mode, and unicast mode at AS layer. For example, if V2X application layer of the UE indicates the mode of communication to V2X layer, the V2X layer may set the mode of communication based on the request of the V2X application layer; otherwise, the V2X layer may set the mode of communication based on the mapping information for a V2X service type. The V2X layer may indicate the mode of communication for the V2X service type to the AS layer. Signaling over control plane over PC5 reference point for unicast mode communication management may be supported. FIG. 4 shows an example of NR PC5 unicast link between 2 UEs.

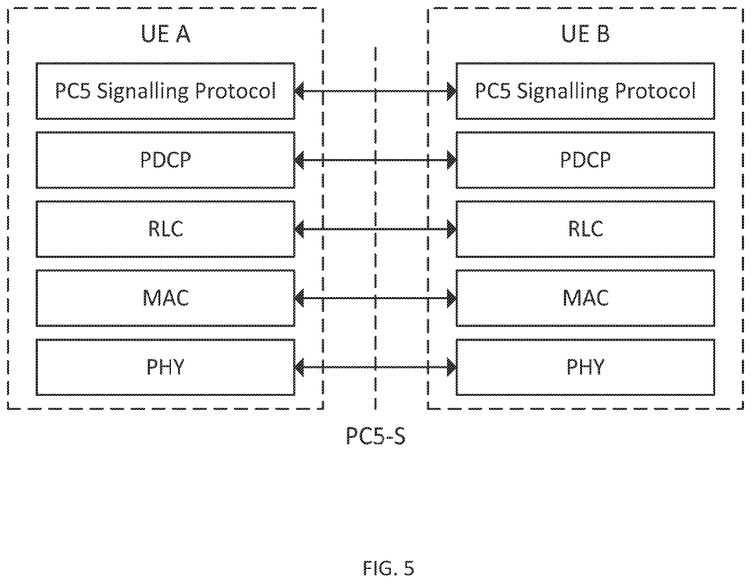

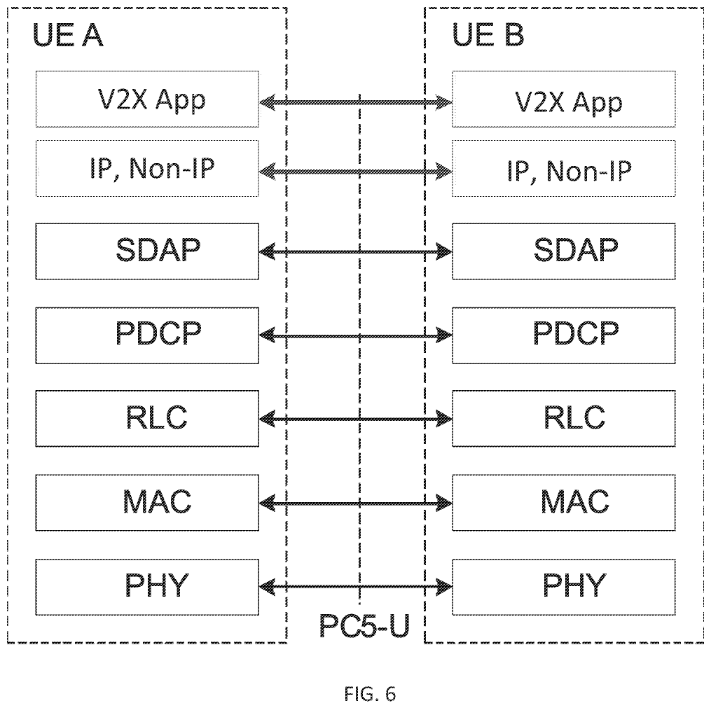

FIG. 5 and FIG. 6 show the control plane and user plane protocol stack defined for NR PC5 interface, respectively.

### V2X Enhancement in Release 17

A pedestrian UE may have a lower battery capacity and limited radio capability, and therefore may have to work in a low power consumption mode, e.g., not being able to send/receive V2X messages with the same periodicity as a Vehicular UE. Continuous sending/receiving V2X messages by the pedestrian UE would affect UE power efficiency.

Various service scenarios for V2X may need to be investigated regarding whether DRX mechanism may be applied or is suitable for V2X services. For example, periodic broadcast of road safety messages by UEs (e.g., one of the main V2X services) should be considered, including broadcast of V2X message by vehicular UEs every 100 msec, broadcast of V2X message by pedestrian UEs every 1 second, etc. In one aspect, this is because the pedestrian UEs have to send the V2X message periodically and/or receive the V2X message periodically, and as such the broadcast periodicity affects DRX cycle.

In one aspect, NR PC5 DRX has an on- and off-durations, and pedestrian UEs with limited power capacities would only turn on its radio interface and perform PC5 transmission/reception during the on-duration.

In one aspect, when the pedestrian UE has multiple PC5 communication sessions, especially with different peer UEs or in different groups, the use of DRX mechanism may result in some traffic missing the on-duration and thus incur longer than usual delays. In other cases, when it is not well coordinated, some transmissions may not be properly received by the UEs, and thus reduce the reliability of the V2X applications. Additionally, different V2X services may have different QoS requirements, e.g., in terms of latency, and traffic pattern. If not coordinated properly, there may be conflicts from these V2X applications, and the DRX mechanism may be rendered unusable.

In one aspect, a pedestrian UE may activate the NR PC5 DRX to reduce power consumption. However, the pedestrian UE may deactivate the NR PC5 DRX to avoid missing V2X messages.

According to some aspects, to support NR PC5 power efficiency for pedestrian UEs, whether and how NR PC5 DRX or other mechanisms may be applied to V2X operation for pedestrian UEs in the 5GS (e.g., study any impact on V2X layer) 5GC may be studied by considering one or more of the following aspects:
(1) whether and how 5GC may authorize the usage of the DRX mechanism and provision the required information to enable the DRX for the pedestrian UE;
(2) whether and how the pedestrian UE may make use of the DRX mechanism without degrading QoS of the PC5 communication;
(3) whether and how to coordinate the requirements from different V2X services so that the QoS and power efficiency may be maintained; and
(4) whether and how the UE activates or de-activates the DRX mode over PC5.

### RAN NR Sidelink Enhancement in Release 17

The Radio Access Network is working on enhancement to sidelink communications, with consideration to both V2X use cases as well as non-V2X use cases such as public safety and commercial use cases. One area of enhancement is power saving, e.g., enabling UEs with battery constraints to perform sidelink operations in a power efficient manner. Rel-16 NR sidelink is designed based on the assumption of “always-on” when a UE operates sidelink, e.g., only focusing on UEs installed in vehicles with sufficient battery capacity. Solutions for power saving in Rel-17 are required for vulnerable road users (VRUs) in V2X use cases and for UEs in public safety and commercial use cases where power consumption in the UEs needs to be minimized.

The term V2X layer is used in reference to the Sidelink non-Access Stratum layer encompassing non-access stratum communication functions and procedures for both sidelink V2X use cases and side link non-V2X use cases.

### Problem Statement

According to some aspects, based on the PC5 protocol stacks and PC5 link models introduced supra, it is desired to develop a PC5 DRX configuration process for enabling the PC5 DRX operation in order to achieve improved power efficiency. A PC5 DRX configuration process describes how a UE determines its PC5 DRX parameters. For example, a PC5 DRX configuration process defines how a UE determines when to use PC5 DRX, the length of its PC5 DRX cycles, when to stop using or deactivate PC5 DRX, and when a PC5 DRX cycle begins and ends. More specifically, the following aspects need to be considered:
In one aspect, there may be more than one PC5 unicast link between a pair of UEs for different services or applications. Since different applications may have different QoS requirements (e.g., latency) and traffic characteristics, it is important to ensure that the PC5 DRX schedule is configured to be suitable for all the PC5 unicast links between the 2 UEs.
In one aspect, a UE may establish multiple PC5 unicast links with different UEs in its proximity for carrying different application data flows concurrently. Unlike Uu communication, which is coordinated and controlled by the RAN node, 2 UEs in a PC5 communication link may configure different DRX schedules based on application requirements such as traffic pattern and network conditions such as radio condition. It is important for a UE that the PC5 DRX schedule on the PC5 links with different UEs are aligned with each other to achieve efficient power consumption.
In one aspect, a UE may participate in multiple PC5 communication links including unicast, multicast and broadcast. For group based PC5 communication, e.g., multicast and broadcast, there may be multiple UEs to receive the data over the PC5 interface. It is not practical to negotiate the PC5 DRX for multicast/broadcast PC5 communication with each individual UE.

It is possible that a UE may keep PC5 and Uu connections active at the same time, therefore it may be necessary to align the DRX schedule configured for PC5 and Uu communications if there are active DRX operation for both connections. Otherwise, it may affect the power efficiency for both PC5 and Uu communications. For example, if DRX is not configured appropriately, the UE may need to frequently enter and exit low power states in order to listen for paging occasions, e.g., it is more power efficient to wake up and listen to paging occasions on both PC5 and Uu at the same time. Moreover, it may be best if PC5 and Uu paging occasions are somewhat aligned so that the UE may listen to both PC5 and Uu paging occasions when the UE wakes up.

According to some aspects, the following issues may be addressed to configure the PC5 DRX:
PC5 DRX schedule may be negotiated between 2 UEs for a PC5 unicast link followed by the configuration procedure. For example, when a UE has multiple PC5 unicast links with different UEs in proximity, multiple negotiation and configuration processes may be performed. According to some aspects, several details are addressed. For example, which entities and layers (e.g., application layer, V2X layer, NAS layer or AS layer) in the protocol stack as shown in FIG. 5 and FIG. 6 are responsible for determining the PC5 DRX parameters and some other tasks (e.g., initiate the PC5 DRX configuration process, provide application requirement information, provide network policy and conditions, send/receive the PC5 DRX configuration message and determine the DRX parameters). In other words, it is desired to define the functional split for PC5 DRX configuration from architectural point of view and protocol stack point of view.

Moreover, it may need to be specified what exact information is used to determine the PC5 DRX parameters, where different information may be provided by different entities and layers in the protocol stack. It is also desired to address what may trigger the PC5 DRX configuration and reconfiguration process, e.g., whether configuration and reconfiguration occurs during the discovery procedure when UE is trying to discover one or more UEs in proximity to establish a PC5 link or during the PC5 link establishment procedure when there is data to transfer over the PC5.

For PC5 multicast and broadcast communication, unlike with the unicast communication, it may not be possible nor efficient to perform negotiation between sender UE and each individual receiver UE. This is because there may be a group of receiver UEs and more UEs may join the group at any time. There may be too much negotiation between the sender UE and each individual UE in the group and this may result in the frequent updates on DRX schedule when a new UE joins the group. It is desired to establish a method on how to configure and reconfigure the PC5 DRX for broadcast and multicast communication.

When a UE has active DRX for both PC5 and Uu connections, it may be necessary to perform some configuration process to align both DRX schedules for better power efficiency. This is because it is more power efficient to wake up and listen to paging occasions on both PC5 and Uu at the same time. In other words, it may be best if PC5 and Uu paging occasions are somewhat aligned so that the UE may listen to both PC5 and Uu paging occasions when the UE wakes up. The alignment may involve both network entities (e.g., AMF and UDM) responsible for Uu DRX configuration and UEs in the PC5 link. It is desired to establish a mechanism on how to align the Uu and PC5 DRX schedule. In addition, by configuring the PC5 DRX, the existing paging occasion may be affected which is set up mainly based on the Uu DRX. It is further desired to establish a mechanism to address this issue.

### Solution

According to some aspects, a method is established to configure the PC5 DRX to achieve the power efficiency for PC5 communications including unicast, groupcast and broadcast . In particular, this invention addresses the following aspects:
According to some aspects, an overall procedure of PC5 DRX negotiation and configuration is presented, showing the functional split from the architectural and protocol stack perspective (e.g., Overall Procedure of Configurating PC5 DRX).
According to some aspects, information is provided by application layer to help generate the assistance information for PC5 DRX configuration (e.g., Application Layer Information for PC5 DRX Configuration).
According to some aspects, assistance information is generated and provisioned to AS layer for PC5 DRX configuration (e.g., Assistance Information from Network and Method of Providing Assistance Information to UE). In one aspect, the network provides the assistance information to UE for the PC5 DRX configuration.
According to some aspects, operations are performed at UE and network once the AS layer provides the determined PC5 DRX parameters (e.g., Network Operation with PC5 DRX Parameters from AS Layer). In one aspect, the Application layer may change the starting point and active transmission window to adapt to the PC5 DRX parameters. In one aspect, a URSP rule may be enhanced by network to reflect the PC5 DRX configuration
According to some aspects, PC5 DRX and Uu DRX may be coordinated by moving UE's paging occasion (e.g., Methods of Coordinating Uu DRX and PC5 DRX Configuration).

### Overall Procedure of Configurating PC5 DRX

According to some aspects, this section discusses the functional split for configuring the PC5 DRX among different entities and different layers in protocol stack by presenting an overall high-level negotiation procedure between UEs for PC5 DRX configuration.

In general, the AS layer may perform the negotiation process between the UEs. In other words, the AS layer of the UEs may be responsible for sending/receiving the PC5 messages and deciding the PC5 DRX parameters. The Application layer may provide some application requirements that may affect the PC5 DRX parameter decision. Network functions such as AMF and PCF/UDM may provide authorization related information and QoS parameters to assist PC5 DRX configuration. The Core Network (e.g., the PCF, UDM, and AMF) may use the UE configuration update procedure to send the assistance information to UE for PC5 DRX configuration.

According to some aspects, there may be several events that may trigger, or cause the UE to initiate a PC5 DRX configuration/update procedure:
First, an event may include when a UE discovers other UEs during the PC5 discovery procedure. The UE that is being discovered may include its PC5 DRX schedules in the discovery message and broadcast the message within the proximity. The Discovery message may also include the PC5 DRX parameters that is configured for existing PC5 unicast link or groupcast/broadcast group.
Second, an event may include when a UE establishes a PC5 unicast link to communicate with another UE during PC5 link establishment procedure. The UE may include the service type information, application information and QoS requirement in the request message that is sent to the target UE. This information may be used by AS layer to determine the PC5 DRX parameters.
Third, an event may include when a UE receives authorization for multicast and/or broadcast over PC5. For groupcast/broadcast over PC5, instead of negotiation with each individual UE in the group, the sender UE may initiate the negotiation process with network and application server to configure the PC5 DRX schedule.
Fourth, an event may include when a UE needs to update existing PC5 DRX for a unicast PC5 link to align with Uu DRX. There may be different ways to coordinate PC5 DRX schedule and Uu DRX schedule. Details are discussed regarding Application Layer Information for PC5 DRX Configuration.
Fifth, an event may include when a UE needs to adjust the existing PC5 DRX due to conflicts with other PC5 DRX for unicast/multicast/broadcast communication. This may be triggered based on the request from the UE on the other side of the PC5 link.
Sixth, an event may include when the Network (e.g., AMF and PCF) requests that the UE reset one or more PC5 DRX schedules under certain conditions.
Seventh, an event may include when the UE turns on Power Saving mode. In this case, the granularity of turning ON the power saving mode may be at the UE level, or specific for power saving for sidelink communication.
Eighth, an event may include when the UE sets the power saving mode to sidelink communication mode for pedestrian.
Ninth, an event may include when the UE sets the power saving mode to power limited communication.
Tenth, the UE may trigger the event based on Battery level, for example the user may configure a battery level threshold, under which operation in DRX mode and supporting configuration is activated.

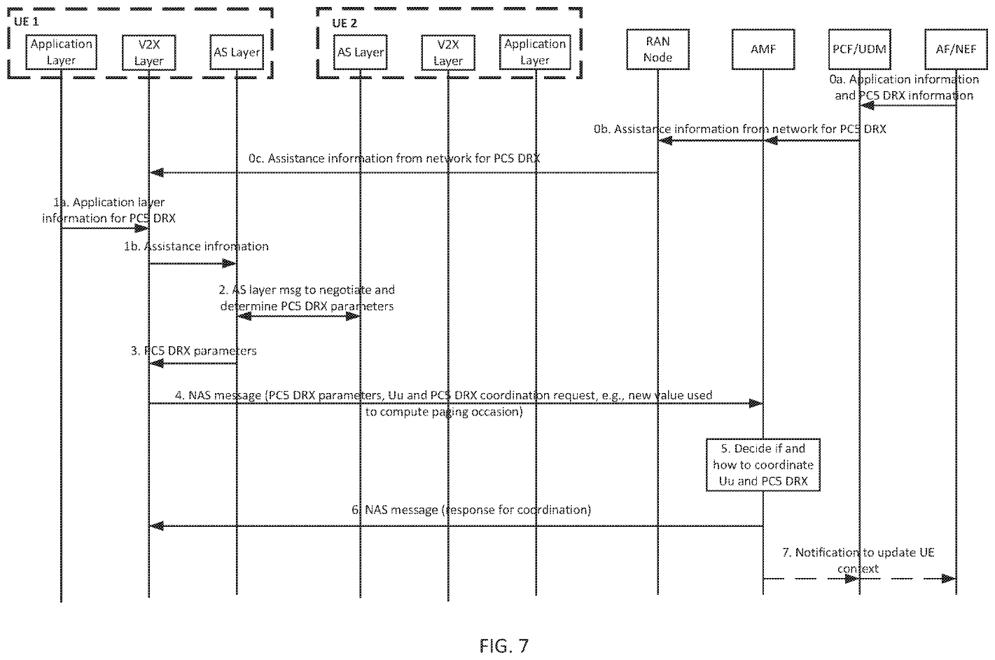

FIG. 7 shows an overall procedure of PC5 DRX configuration between 2 UEs and the subsequent network operation based on the PC5 DRX parameters to coordinate the Uu and PC5 DRX schedule.

Step 0a: An application function or application server provides the application specific information related to the PC5 DRX to a network function, such as PCF or UDM. If the information is sent to PCF, then the PCF may derive the QoS parameters or PC5 DRX pattern based on the application layer information. If UDM gets the information from AF, it may send notification including the application layer information to PCF or AMF depending on which network function subscribes to the event at UDM. Note that AF may communicate with network function via NEF, which may turn the external application information (e.g., application ID) to the internal application information. The detailed information that is sent to network is discussed regarding Application Layer Information for PC5 DRX Configuration.

Step 0b: The PCF or UDM sends the PC5 DRX assistance information for PC5 DRX configuration to the AMF, which forwards the information to the RAN node by an N2 message. Alternatively, the AMF may send a NAS message to the UE with the same assistance information. What information is included in the network assistance information is discussed regarding Assistance Information from Network. Moreover, the PCF/UDM may provide authorization related information to UE about the PC5 communication and PC5 DRX. For example, PCF may indicate the maximum number of different PC5 DRX configuration or schedules a UE may have to avoid too complex coordination. PCF may also restrict the maximum number of different PC5 DRX patterns a UE may use.

Step 0c: The RAN node forwards the network assistance information to the V2X layer of UE. The step 0a˜0c may be performed by pre-configuration to UE or provisioned to UE during the registration procedure when UE registers to the network. Alternatively, the application server may send the application specific PC5 DRX configuration to UE using application layer signaling.

Step 1a: The application layer of UE sends the application specific information for PC5 DRX configuration. The details of application specific information are presented regarding Application Layer Information for PC5 DRX Configuration. This message may be triggered by step 0c, or any of the triggers that were discussed earlier.

Step 1b: The V2X layer of UE 1 provides the assistance information to the AS layer to determine the PC5 DRX parameters. This message may be triggered by step 0c, or any of the triggers that were discussed earlier.

Step 2: The UE 1 and UE 2 AS Layers negotiate the PC5 DRX over the PC5 interface. The AS layer is sending and receiving the PC5 messages to determine the PC5 parameters.

Step 3: Once the PC5 DRX parameters are determined, the AS layer provides the negotiated PC5 DRX parameters to the V2X layer.

Step 4: The UE sends the NAS message to AMF including the negotiated PC5 DRX parameters. Moreover, the UE may request the network to coordinate the PC5 DRX with its existing Uu DRX. The request may include the preferred coordination method and the new parameters. More details are discussed regarding Methods of Coordinating Uu DRX and PC5 DRX Configuration.

Step 5: The AMF may decide whether and how to coordinate the Uu DRX and the PC5 DRX. For example, AMF may decide to move the UE's paging occasion so that UE does not need to listen during the off period of PC5 DRX. AMF may decide to deactivate or activate the PC5 DRX in certain time period or periodically.

Step 6: The AMF sends an NAS message as the response to the UE's request to coordinate PC5 DRX and Uu DRX. The response message may include the parameters and/or method that may be used by UE for coordination.

Step 7: Optionally, AMF may send a notification to UDM and AF if some UE context is changed due to the coordination between PC5 DRX and Uu DRX.

It is noted that the PC5 DRX configuration may be triggered by some other procedures, such as PC5 link establishment procedure and PC5 discovery. Note that UE 2 may also send and receive messages from the network to coordinate its PC5 DRX configuration with the network, although this is not shown in the figure. Moreover, the AS layer may send the determined PC5 DRX parameters to the V2X layer at the UE 2 as well once the negotiation is completed.

### Method of Assistance Information Provision for PC5 DRX Configuration

According to some aspects, this section discusses the information provided by network and application that may be used by AS layer to determine the PC5 DRX. As shown in the overall high-level procedure above, the PC5 DRX assistance information may be provided to the AS layer for final determination of PC5 DRX parameters. Moreover, this section presents how to provide such assistance information to UEs and what network may do with the PC5 DRX related information provided by AS layer.

### Application Layer Information for PC5 DRX Configuration

The Application layer may provide information to V2X layer (e.g., network) to help the network determine the assistance information that is provided to UE/RAN node for PC5 DRX configuration. The application information may come from the application running on the UE or the application server that manages the application as AF or AS. The application layer may provide the following information to V2X layer for PC5 DRX configuration:
First, information provided to V2X layer for PC5 DRX configuration may include a Service type (e.g., V2X, URLLC, mission critical, delay tolerant) or application type (e.g., application ID, OS ID, mission critical, delay tolerant) to indicate the type of application.
Second, information provided to V2X layer for PC5 DRX configuration may include a Traffic pattern that indicates the characteristic of the application traffic, such as the peak data rate of the application data flow, periodicity of the traffic, and active transmission window.
Third, information provided to V2X layer for PC5 DRX configuration may include a Traffic type that indicate aperiodic or periodic communication. In the case of off aperiodic traffic, expected maximum duration between packet, or minimum duration between packet, or both. In the case of periodic traffic, the expected traffic pattern.
Fourth, information provided to V2X layer for PC5 DRX configuration may include a service area of the application, e.g., TA, RA or geographic location.
Fifth, information provided to V2X layer for PC5 DRX configuration may include an applicable communication type, e.g., unicast, groupcast, broadcast or any combination.
Sixth, information provided to V2X layer for PC5 DRX configuration may include Application layer QoS parameters.
Seventh, information provided to V2X layer for PC5 DRX configuration may include a default DRX pattern with DRX parameters. The Application server may directly set up its preferred DRX pattern based on the traffic pattern or the application layer QoS requirements. Alternatively, the application may provide an ID to indicate the DRX pattern, so that network may figure out the corresponding PC5 DRX parameters. For example, a default DRX pattern may consist of a maximum time period between paging occasions. Furthermore, a default DRX pattern may consist of times when the UE must be available or need not be available. Furthermore, a default DRX pattern may consist to a maximum percentage of time that the application may use DRX over a time period.
Eight, for groupcast or broadcast, application layer may further provide some information about the group. For example, application layer group ID for the application, max size of group.
Ninth, information provided to V2X layer for PC5 DRX configuration may include a communication mode that is associated with any application layer information. For example, the application layer may provide N sets of information to the V2X Layer, the information set may be used by the V2X Layer to derive N sets of DRX configurations. For example, the Application Layer provide N service type, N QoS parameters, N default DRX parameters, etc. Each of the N sets may be associated with an application layer operating mode and the application may indicate to the V2X Layer which mode it is operating in so that the V2X Layer may apply the corresponding DRX configuration. Examples of operating modes may be active, dormant, group leader, group member, smayning, downloading, incoming message expected, incoming message not expected, etc.

The application layer may also provide services for determining PC5 configuration ranges obtained by considering the status of multiple links. The application layer may provide the following information for PC5 DRX configuration:
First, information for PC5 DRX configuration may include a DRX rank, which may be used to determine whether to use DRX or not, or when. For example, when power savings are enabled, the PC5 links with the highest DRX rank are the last ones to be switched to DRX and allocated the maximized active time, therefore preserving quality.
Second, information for PC5 DRX configuration may include a DRX unit identifier, which may be used so all the links in the same unit (e.g., group) have DRXs cycles synched-up (or attempted to) between them by Application Server. A “unit identifier” may be further used to harmonize QoS requirements within the unit.

For example, the application layer on UE X, with multiple PC5 links may provide information that a PC5 link A should have a higher DRX rank than PC5 link B, given that the communication over PC5 link A is more critical than for PC5 link B. This informs the V2X layer to allocate link A DRX pattern with a maximized active time. Similarly, it may configure that PC5 link A should never have DRX enabled or configured, and only PC5 link B DRX parameters may be negotiated.

In another example, the application layer on the network side may provide the same DRX Unit identifiers for all the PC5 links on a UE X hosting multiple sensors. This informs the V2X layer that the DRX patterns of the PC5 links in the same unit should be aligned to maximize power savings. At the same time, the PC5 links on a controller UE Y (with which UE X communicates) may not be grouped in a DRX unit, as achieving power savings at the controller is less important than achieving it at the sensor UEs.

Assistance Information from Network

According to some aspects, V2X layer generates the assistance information and passes it to the AS layer for the PC5 DRX configuration based on both the network information and the information received from the application layer. The network assistance information may consist of the following information:
First, the network assistance information may include PC5 QoS parameters for a PC5 link, such as PQIs, max data rate per PC5 link or QoS flow
Second, the network assistance information may include a DRX pattern which may be a recommended time period or on-off duration for the PC5 DRX specific to the application or service, or may be an ID to identify a DRX pattern that was configured and sent to UE, so that UE knows what parameters to use. A DRX pattern may further consist of a start and end time. The start time may indicate when the DRX patter should begin. For example, the pattern may indicate that the time between paging occasions may be 15 minutes, but there should be a paging occasion at the turn of an hour. Alternatively, the pattern may indicate times when DRX should not be used.
Third, the network assistance information may include a Mapping of service type/application information to the QoS parameters: the mapping information may be used by the UE to derive the QoS parameters in case that the QoS is not available or not provided by the network.
Fourth, the network assistance information may include a mapping of service type/application information to DRX pattern: this mapping information is used by the UE to derive the DRX pattern or parameters for PC5 DRX based on the service type or application information such as application ID.
Fifth, the network assistance information may include a traffic pattern information: indicate the characteristic of the application traffic, such as the peak data rate of the application data flow, periodicity of the traffic, and active transmission window.
Sixth, the network assistance information may include a source/destination layer 2 ID: this is used to identify the PC5 link for the PC5 DRX configuration.
Seventh, the network assistance information may include a communication type that associates the assistance information with a certain type of PC5 communication, e.g., unicast, groupcast or broadcast.
Eighth, the network assistance information may include for the groupcast and broadcast communication, V2X layer may further provide the service area information or location information as well as a group ID which may be application layer group ID, layer 2 destination ID for groupcast/broadcast or TMGI.
Ninth, the network assistance information may include DRX rank and/or DRX unit identifier, as described supra. Note that in some aspects, the DRX and DRX unit identifier may be determined by the V2X layer, rather than be provided by the application layer.

### Method of Providing Assistance Information to UE

According to some aspects, the network needs to provide the assistance information to UE, so that the AS layer of UE is able to determine the PC5 DRX parameters when it is needed. It is possible to use the following ways to provide the assistance information to the UE:
First, the information may be pre-configured at UE as a part of default configuration for PC5 communication parameters. The pre-configured information may be used as the default values in the out-of-coverage case or when the network provisioned assistance information is not available.
Second, the network may send the information to UE using the NAS message. This may be based on the UE's request or AF's request. For example, AMF may send the registration accept message to the UE in registration or registration update procedure. PCF may send UE configuration update message to UE. Optionally, the network (e.g., AMF) may send the N2 message to the RAN node, which then forwards the assistance information to the UE. In this way, the RAN node knows the parameters on the possible PC5 communication, so that RAN node is able to manage the radio resource for the future PC5 communication.
   Network Operation with PC5 DRX Parameters from AS Layer

According to some aspects, after the AS layer determines the PC5 DRX parameters, the AS layer may provide the determined parameters to the V2X layer of the UE. Moreover the information may be sent to network as well as shown in the steps 3 and 4 of FIG. 7. This section discusses what the V2X layer and application layer of the UE may do and what the network may do with the PC5 DRX parameter from the AS layer.

At the UE, once the V2X layer receives the PC5 DRX parameters from the AS layer, the V2X layer of the TX UE (e.g., UE 2 in FIG. 7) may notify the application layer to adjust the traffic schedule so that the application layer may send application data to the RX UE when the RX UE is in the “on” time (e.g., it is close to the paging occasion of the Rx UE). Since the PC5 DRX is configured per source/destination pair, the application layer may adjust the schedule of other applications to align with the PC5 DRX schedule. This may be applied to other application data flows that are transferred over the same PC5 links, or different PC5 links. Moreover, this may be also applied to the uplink data transferred over Uu. The application layer may change the transmission duration and/or the starting point for an application data flow. Alternatively, the V2X layer may notify the application layer that the traffic schedule may be adjusted at the indicated active transmission window due to the PC5 DRX configuration. For the PC5 groupcast or broadcast, the UE may broadcast the PC5 DRX parameters over the PC5 interface with the application information and group ID (e.g., layer 2 destination ID or application layer group ID). The information may be carried in an AS layer message or V2X layer message (e.g., PC5 discovery message).

At the network side, based on the PC5 DRX parameters received from the UE (e.g., step 4 in FIG. 7), the network may update a URSP rule which includes an indicator in the traffic descriptor that PC5 may be used for communication. Specifically, the PCF may add or update the active transmission window associated with the PC5 enabled indicator. Therefore, when UE checks the URSP rules to pick PC5 link or PDU session for data transfer, it knows when the PC5 link may be used to transfer data, e.g., when the PC5 link may be on. Alternatively, PCF may add or update a time window attribute to indicate when to use the PC5 link to send the data traffic. Then the PCF may send the updated URSP rule to the UE. Moreover, if the network maintains a set of PC5 DRX patterns and each of these patterns are used for a set of applications with similar QoS or traffic characteristics, then the network may create a new PC5 DRX pattern with a new ID. The new pattern is mapped to a set of QoS parameters and kept in the UDM. In the future, the network may provide the ID to identify the PC5 DRX pattern when application data is transferred over PC5 with the similar QoS parameters.

AS Layer Information to V2X layer or Application Layer

The AS layer may provide DRX configuration information to the V2X layer or Application Layer. For example, the AS layer may provide one or more DRX configuration parameters or DRX configuration parameter sets to the V2X layer or to the Application layer. In one aspect, the V2X layer or the application layer may use such DRX configuration parameters from the AS layer, to make a decision on how to configure Sidelink (e.g., PC5 link) communication. For example, the V2X layer or the Application layer or the V2X layer in coordination with the application layer, may use the received DRX configuration information from the AS layer, to align sidelink transmission timing and DRX timing. For example, the V2X layer or the Application layer or the V2X layer in coordination with the application layer, may use the received DRX configuration information from the AS layer, to decide on which sidelink data packet to submit to the AS layer for transmission, or to decide on the timing for a sidelink data packet transmission, or to decide on whether to buffer packet, and which packet to buffer while transmission is pending. In another embodiment, the V2X layer or the application layer or the V2X layer in coordination with the Application layer may use the DRX configuration information from the AS layer to decide or suggest to the AS layer, the DRX configuration that the AS layer should use. For example, the AS layer may provide to the V2X layer, several candidate DRX configuration sets. The V2X layer or the Application layer or the V2X layer in coordination with the Application layer, select one (or more) DRX configuration sets from the candidate sets received from the AS, ad communicate the selected subset to the AS as the DRX configuration parameters to use by the AS or as the preferred DRX configuration parameters to use by the AS. Alternatively, the V2X layer or the Application layer or the V2X layer in coordination with the Application layer, may communicate to the AS layer, one or more DRX configuration parameter sets for example from the received sets from the AS, which are not preferred by the V2X layer or the Application layer.

### Methods of Coordinating Uu DRX and PC5 DRX Configuration

According to some aspects, this section focuses on the method of how to align the Uu DRX schedule with PC5 DRX schedule when a UE has DRX active on both interfaces at the same time.

Assuming that the Uu DRX is set up before PC5 DRX is configured, when a UE has its PC5 DRX determined, the UE may find out that the Uu DRX and the existing paging occasion do not align with the PC5 DRX. In other words, the UE may need to listen to the paging over Uu while it stays in the off period according to the configured PC5 DRX cycle. To avoid this inefficiency, the UE may send an NAS message (e.g., e.g., step 4 in FIG. 7) to the network requesting network to move its Uu paging occasion. The NAS message may be a registration update or a service request. In the request message, the UE may include the suggested parameters so that the network may derive the new paging occasion for the UE. For example, the UE may choose to propose to use an Alternative IMSI Offset value based on the UE's PC5 DRX or PC5 paging occasion. In other words, the UE indicates to the network an offset value that would align the Uu DRX configuration with that of the PC5 DRX configuration. Alternatively, the UE may just insert the PC5 DRX parameters (e.g., on and off duration, and offset value) to the network. In the request, the UE may also include an indicator that it requests to update the Uu paging occasion and the reason for the request, e.g., possible collision due to the new PC5 DRX configuration.

When the network receives the NAS message from the UE, network entity (e.g., AMF or MME) may decide whether or not to accept the request to move UE's paging occasion. If the network decides to accept the request, then the network needs to decide how to move UE's paging occasion. The network may move the paging occasion by using the value suggested by the UE in the request if any and include the value in the response message sent to UE. The network may also decide to apply a different value other than the Alternative IMSI Offset value proposed by the UE. Moreover, it is also possible that the network decides to adjust the Uu DRX cycle to align with the PC5 DRX. In the response, the AMF or MME may include the value adopted by the network or the new Uu DRX parameters to assist UE to compute the paging parameters. In case that the network rejects the request, the network may return the response with the rejection indicator and the reason for the rejection. It is possible that network entity (e.g., AMF) asks UE to notify the network when there is a potential collision due to the PC5 DRX and Uu DRX. In this case, the network may determine the value used for paging occasion calculation and send it the UE upon receiving the notification from the UE.

Moreover, the network (e.g., PCF/AF) may set up some policies about how to align PC5 DRX with Uu DRX and send the policy to the UE, e.g., so that the UE may apply the policy when configuring the PC5 DRX and calculating the paging occasion by considering both Uu and PC5 DRX parameters. Based on the policy, the UE may perform the DRX negotiation for both PC5 and Uu communication with other UE and network respectively. When the DRX parameters are determined, the UE may decide what value to use for paging occasion computation based on the policy and notify network the new value. The policy may cover the case of DRX configuration for unicast, groupcast and broadcast communication over PC5. The policy may include the following information:
First, the policy may include the maximum number of PC5 DRX patterns that a UE may have for its PC5 communications.
Second, the policy may include the maximum number of PC5 DRX that may be configured for PC5 links.
Third, the policy may include the maximum on/off duration for a PC5 DRX and the percentage ratio between on and off
Forth, the policy may include the location where the policy may be applied.
Fifth, the policy may include a default/suggested value used for paging occasion calculation if PC5 DRX conflicts with Uu DRX.
Sixth, the policy may include a default PC5 DRX pattern for groupcast and broadcast
Seventh, the policy may include the mapping information between service type/application ID and the PC5 DRX pattern/parameters
Eight, the policy may include an indication of whether the network prefers that the UE adjust PC5 DRX cycles to align with Uu DRX cycles or if the network prefers that the UE adjust Uu DRX cycles to align with PC5 DRX cycles.

For groupcast and broadcast PC5 communication, the PC5 DRX may not be negotiated with each individual UE in the group, and PC5 DRX is likely configured per group, per service area or per service/application. Network function (e.g., AMF) may subscribe to the application server and network function (e.g., AF, PCF or MBSF) for the PC5 DRX parameters that authorize the PC5 groupcast and/or broadcast for certain service application. Based on the parameters in the notification received, the network may decide whether to move the paging occasion for the UE and what value to be used for paging occasion calculation.

### User Interface

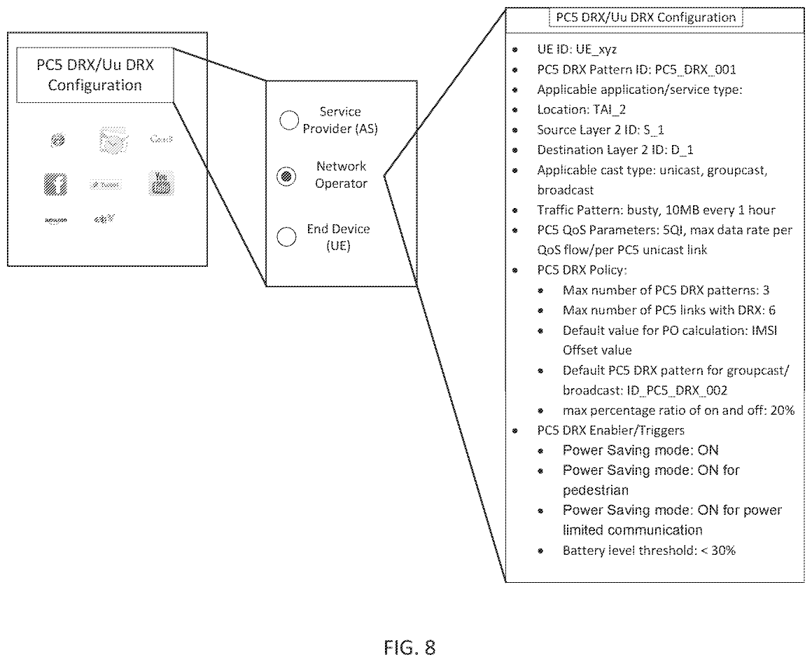

The parameters and assistance information for PC5 DRX configuration may be provisioned by the end user (UE), network operator, or application service provider through a user interface. The user interface may be implemented for configuring or programming those parameters with default values, as well as enabling or PC5 DRX. An exemplary user interface is shown in FIG. 8.

### Example Communications System

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that may provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

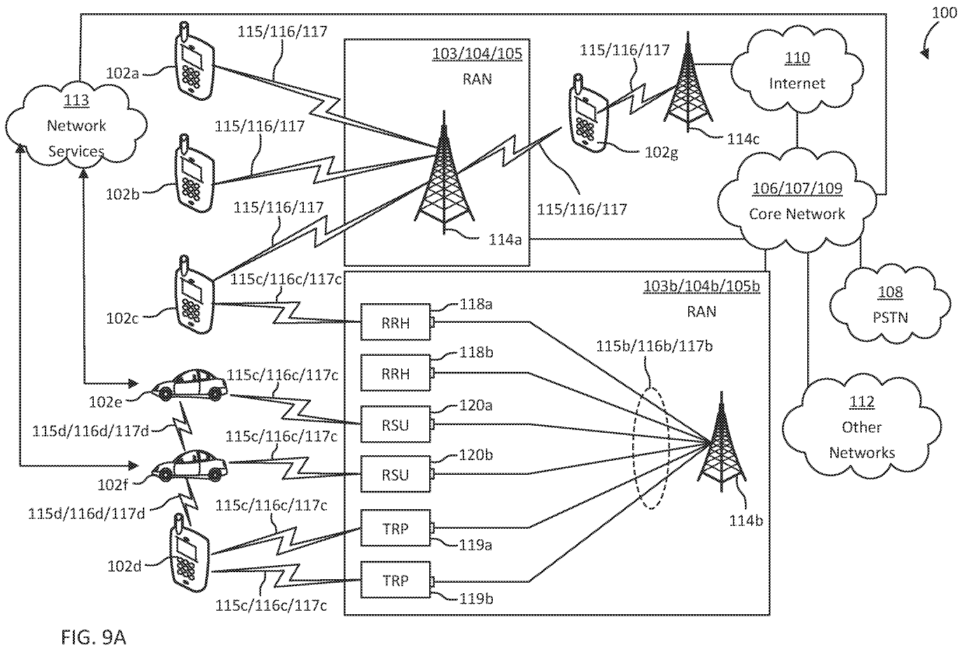

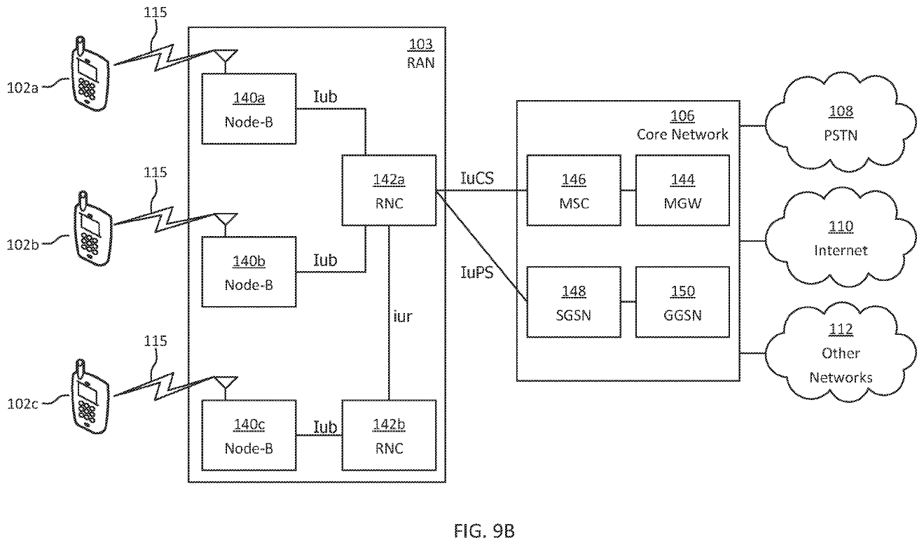

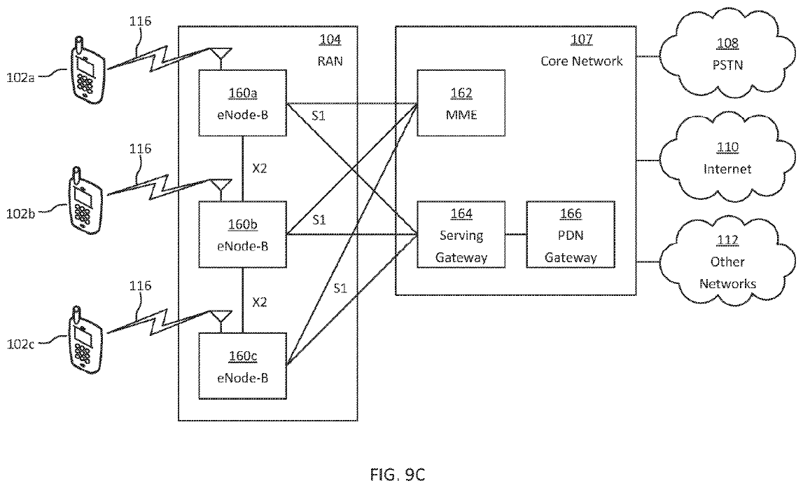

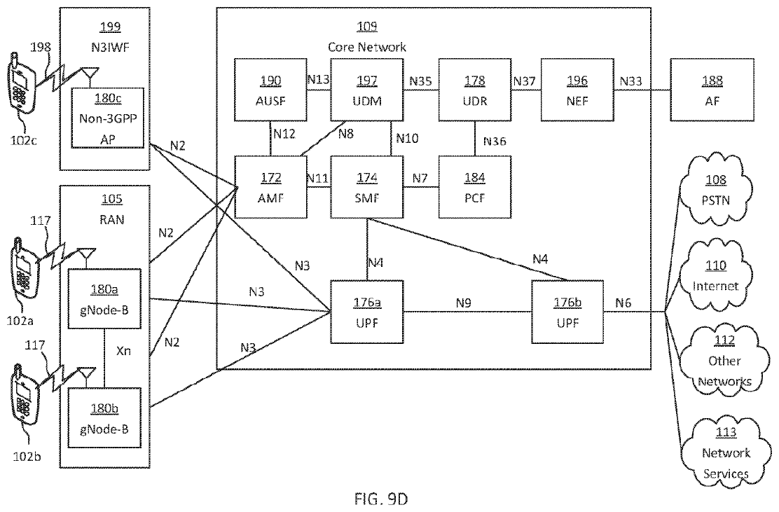

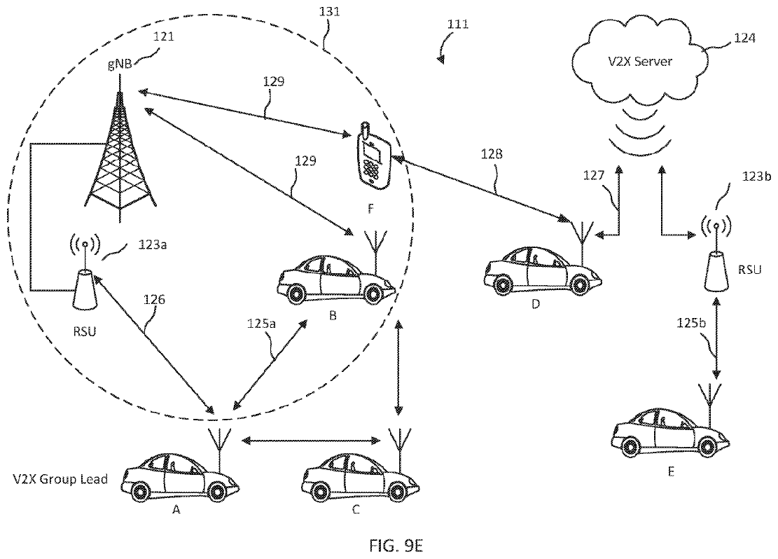

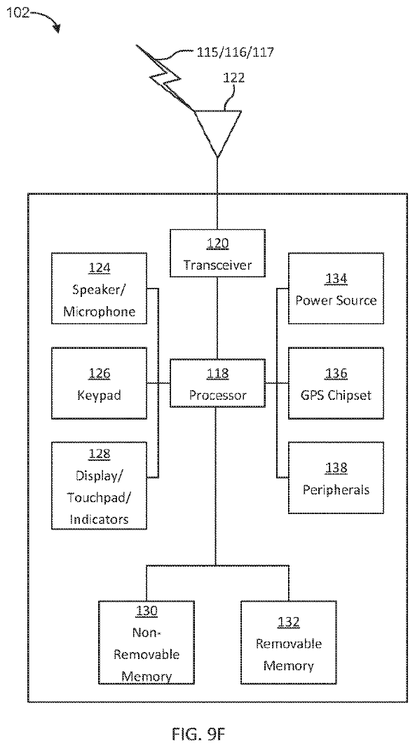

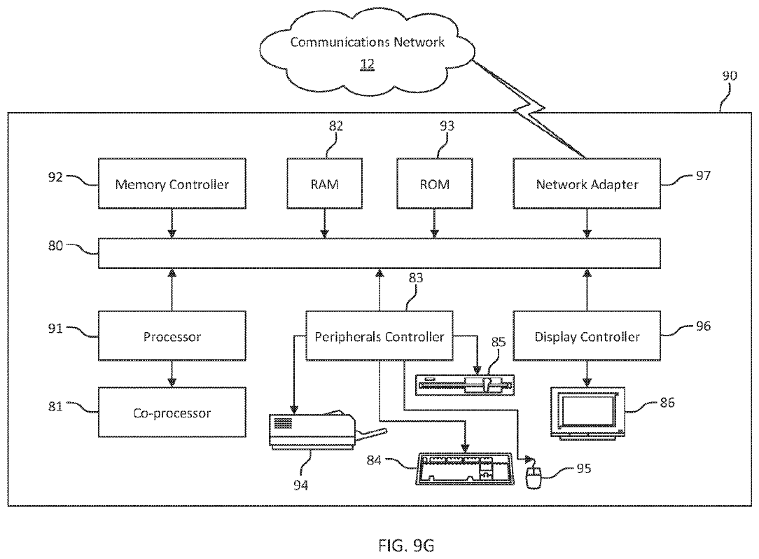

FIG. 9A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It may be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 9A, each of the WTRUs 102 is depicted in FIGS. 8A-8E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 9A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b,TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 9A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 9A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 9A, it may be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 9A may be configured to communicate with the base station 114a, which may employ a cellular-based radio technology, and with the base station 114c, which may employ an IEEE 802 radio technology.

Although not shown in FIG. 9A, it may be appreciated that a User Equipment may make a wired connection to a gateway. The gateway maybe a Residential Gateway (RG). The RG may provide connectivity to a Core Network 106/107/109. It may be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 9B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 9B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It may be appreciated that the RAN 103 may include any number of Node-Bs and Radio Network Controllers (RNCs.)

As shown in FIG. 9B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 9B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it may be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 9C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it may be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 9C, the eNode-Bs 160a, 160b, and 160c may communicate with one another over an X2 interface.

The core network 107 shown in FIG. 9C may include a Mobility Management Gateway (MME) 162, a serving gateway 164, and a Packet Data Network (PDN) gateway 166. While each of the foregoing elements are depicted as part of the core network 107, it may be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the Si interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 9D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It may be appreciated that the RAN 105 may include any number of gNode-Bs. The gNode-Bs 180a and 180b may each include one or more transceivers for communicating with the WTRUs 102aand 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It may also be appreciated the RAN 105 may employ more than one type of base station. For example, the RAN may employ eNode-Bs and gNode-Bs.

The N3IWF 199 may include a non-3GPP Access Point 180c. It may be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 9D, the gNode-Bs 180a and 180b may communicate with one another over an Xn interface, for example.

The core network 109 shown in FIG. 9D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 9G.

In the example of FIG. 9D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it may be appreciated that any one of these elements may be owned and/or operated by an entity other than the core network operator. It may also be appreciated that a 5G core network may not consist of all of these elements, may consist of additional elements, and may consist of multiple instances of each of these elements. FIG. 9D shows that network functions directly connect to one another, however, it should be appreciated that they may communicate via routing agents such as a diameter routing agent or message buses.

In the example of FIG. 9D, connectivity between network functions is achieved via a set of interfaces, or reference points. It may be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 9D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 9D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function may add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators may use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 9D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 8A, 8C, 8D, and 8E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 8A, 8B, 8C, 8D, and 8E are provided by way of example only, and it is understood that the subject matter disclosed and claimed herein may be embodied or implemented in any similar communication system, whether presently defined or defined in the future.

FIG. 9E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 9E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 9E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 9F is a block diagram of an example apparatus or device WTRU 102 that may be configured for wireless communications and operations in accordance with the systems, methods, and apparatuses described herein, such as a WTRU 102 of FIG. 9A, 8B, 8C, 8D, or 8E. As shown in FIG. 9F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It may be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 9F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 9F depicts the processor 118 and the transceiver 120 as separate components, it may be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 9A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It may be appreciated that the transmit/receive element 122 may be configured to transmit and/or receive any combination of wireless or wired signals.

In addition, although the transmit/receive element 122 is depicted in FIG. 9F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It may be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 9G is a block diagram of an exemplary computing system 90 in which one or more apparatuses of the communications networks illustrated in FIGS. 8A, 8C, 8D and 8E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that may not easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 8A, 8B, 8C, 8D, and 8E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

1-20. (canceled)

21. A first wireless transmit/receive unit (WTRU), comprising a transceiver and one or more processors, configured to:
receive, from a policy control function (PCF), PC5 discontinuous reception (DRX) information, wherein the PC5 DRX information associates a PC5 DRX cycle with corresponding application layer information;
determine, based on the PC5 DRX information and the application layer information received by the first WTRU from an application layer, one or more first PC5 DRX parameters;
send or receive, by the first WTRU, negotiation information to perform a negotiation with a second WTRU;
determine, based on the negotiation with the second WTRU and the DRX information, one or more second PC5 DRX parameters; and
configure, based on the one or more second PC5 DRX parameters, a PC5 interface.

22. The first WTRU of claim 21, wherein the first WTRU is further configured to:
receive a user equipment route selection policy (URSP) rule indicating a type of application layer traffic associated with a PC5 link; and
route application traffic through the PC5 link based on the URSP rule.

23. The first WTRU of claim 22, wherein the URSP rule comprises a route selection descriptor and the application traffic is routed based on the route selection descriptor.

24. The first WTRU of claim 21, wherein the first WTRU is further configured to transmit a non-access stratum (NAS) message comprising a request for an alternative international mobile subscriber identity (IMSI) offset value, wherein the alternative IMSI offset value is based on the PC5 DRX cycle and is used to determine a Uu paging occasion.

25. The first WTRU of claim 21, wherein the PC5 DRX information is determined based on one or more quality of service (QoS) parameters and the PC5 DRX cycle is associated with the corresponding application layer information based on the one or more QoS parameters.

26. The first WTRU of claim 21, wherein the one or more second PC5 DRX parameters comprise a service type.

27. The first WTRU of claim 21, wherein the PC5 interface comprises one or more PC5 DRX triggers.

28. The first WTRU of claim 27, wherein the one or more PC5 DRX triggers comprise a power saving mode parameter.

29. A method performed by a first wireless transmit/receive unit (WTRU), the method comprising:
receiving, from a policy control function (PCF), PC5 discontinuous reception (DRX) information, wherein the PC5 DRX information associates a PC5 DRX cycle with corresponding application layer information;
determining, based on the PC5 DRX information and the application layer information received by the first WTRU from an application layer, one or more first PC5 DRX parameters;
sending or receiving, by the first WTRU, negotiation information to perform a negotiation with a second WTRU;
determining, based on the negotiation with the second WTRU and the DRX information, one or more second PC5 DRX parameters; and
configuring, based on the one or more second PC5 DRX parameters, a PC5 interface.

30. The method of claim 29, further comprising:
receiving a user equipment route selection policy (URSP) rule indicating a type of application layer traffic associated with a PC5 link; and
routing application traffic through the PC5 link based on the URSP rule.

31. The method of claim 30, wherein the URSP rule comprises a route selection descriptor and the application traffic is routed based on the route selection descriptor.

32. The method of claim 29, wherein the first WTRU is further configured to transmit a non-access stratum (NAS) message comprising a request for an alternative international mobile subscriber identity (IMSI) offset value, wherein the alternative IMSI offset value is based on the PC5 DRX cycle and is used to determine a Uu paging occasion.

33. The method of claim 29, wherein the PC5 DRX information is determined based on one or more quality of service (QoS) parameters and the PC5 DRX cycle is associated with the corresponding application layer information based on the one or more QoS parameters.

34. The method of claim 29, wherein the one or more second PC5 DRX parameters comprise a service type.

35. The method of claim 29, wherein the PC5 interface comprises one or more PC5 DRX triggers.

36. The method of claim 35, wherein the one or more PC5 DRX triggers comprise a power saving mode parameter.

37. A system comprising:
one or more processors; and
memory coupled with the one or more processors, the memory storing executable instructions that when executed by the one or more processors cause the one or more processors to effectuate operations comprising:
receiving, from a policy control function (PCF), PC5 discontinuous reception (DRX) information, wherein the PC5 DRX information associates a PC5 DRX cycle with corresponding application layer information;
determining, based on the PC5 DRX information and the application layer information received by a first WTRU from an application layer, one or more first PC5 DRX parameters;
sending or receiving, by the first WTRU, negotiation information to perform a negotiation with a second WTRU;
determining, based on the negotiation with the second WTRU and the DRX information, one or more second PC5 DRX parameters; and
configuring, based on the one or more second PC5 DRX parameters, a PC5 interface.

38. The system of claim 37, the operations further comprising:
receiving a user equipment route selection policy (URSP) rule indicating a type of application layer traffic associated with a PC5 link; and
routing application traffic through the PC5 link based on the URSP rule.

39. The system of claim 38, wherein the URSP rule comprises a route selection descriptor and the application traffic is routed based on the route selection descriptor.

40. The system of claim 37, wherein the operations further comprise transmitting a non-access stratum (NAS) message comprising a request for an alternative international mobile subscriber identity (IMSI) offset value, wherein the alternative IMSI offset value is based on the PC5 DRX cycle and is used to determine a Uu paging occasion.
